(19) United States
(12) Patent Application Publication
(10) Pub. No.: US 2008/0204922 A1
(43) Pub. Date: Aug. 28, 2008

(54) Methods and apparatus to monitor hard-disk drive head position

(76) Inventors: Motomu Hashizume, Tokyo (JP); Hiroyuki Mukai, Yokohama-shi (JP); Yukihisa Hirotsugu, Tokyo (JP); Hidetaka Kuroiwa, Kawasaki-shi (JP); Naoko Jinguji, Kanagawa (JP)

Correspondence Address: TEXAS INSTRUMENTS INCORPORATED, P O BOX 655474, M/S 3999, DALLAS, TX, 75265, US

(21) Appl. No.: 11/712,049

(22) Filed: Feb. 28, 2007

(51) Int. Cl. G11B 21/02

(52) U.S. Cl. 360/75

(57) ABSTRACT

Methods and apparatus to monitor hard-disk drive head position are described. In one example, a hard-disk drive system includes a hard-disk drive platter, a hard-disk drive read head configured to read information from the hard-disk drive platter, and a hard-disk drive head position detector configured to a receive a signal via the hard-disk drive read head and to determine if oscillations in the distance between the hard-disk drive platter and the hard-disk drive read head indicate that contact between the hard-disk drive platter and the hard-disk drive read head is likely to occur

### TECHNICAL FIELD

The present disclosure pertains to computer systems and, more particularly, to methods and apparatus to monitor hard-disk drive (HDD) head position.

### BACKGROUND

Hard-disk drives use one or more disks or platters that rotate about a spindle with respect to one or more heads, such as read and/or write heads. The read or write heads read information from or impart information to the disk platters, but do not, in desired operation, physically contact the platters. To the contrary, HDD heads are suspended above the spinning platters.

Recently, HDD heads have been designed to operate close to platters to communicate therewith. For example, a HDD read head may be positioned very close to a platter to read information from the platter via a reproduction signal. However, close HDD head proximity to the spinning platter increases the risk that the head may come in contact with the platter surface. Contact between a HDD head and a platter may cause performance degradation or destruction of the platter and/or head. An understanding of when a head is likely to contact a platter provides the ability to change operational aspects of the HDD to reduce or eliminate the risk of the head contacting the platter.

### BRIEF DESCRIPTION OF THE DRAWINGS

FIG. 1 is a diagram of a system including a HDD and a circuit to detect HDD head position.

FIG. 2 is schematic diagram showing additional detail of the drive read and control and the HDD head position detector of FIG. 1.

FIG. 3 is plot of various electrical signals against time in a functioning circuit constructed in accordance with the schematic of FIG. 2.

FIG. 4 is a flow diagram of an example monitor HDD head position process.

### DETAILED DESCRIPTION

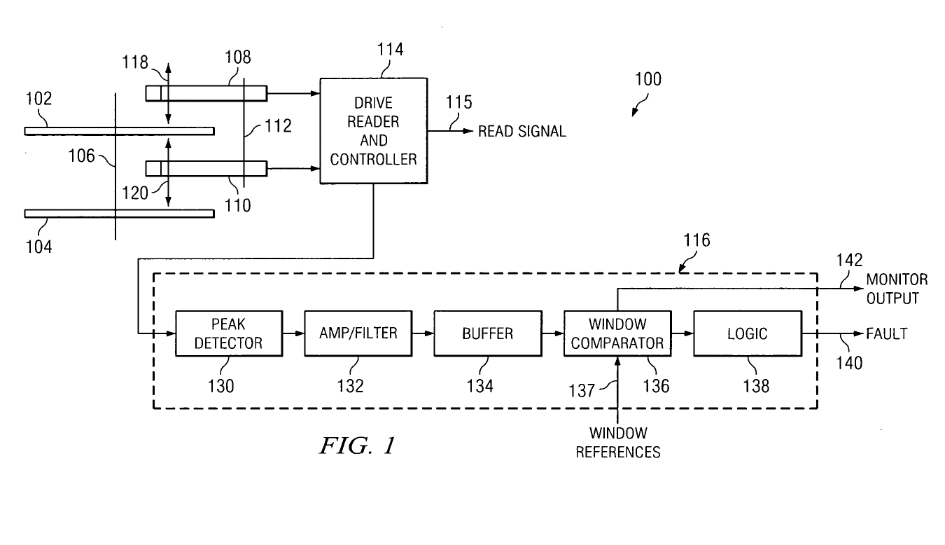

As shown in FIG. 1, a HDD system 100 of a computer may include one or more platters 102, 104 that spin about a spindle 106. One or more read or write heads 108, 110, which pivot about an axis 112, are provided above the platters 102, 104 for reading information from or writing information to the platters 102, 104.

In the read context, the heads 108, 110 are coupled to a drive reader and controller 114, which, as described below in detail, processes signals from the heads 108, 110 to produce a read signal 115. The read signal 115 may be passed to any number of different circuits that are provided in conjunction with processing signals from a HDD. Signals from the drive reader and controller 114 are also coupled to a HDD head position detector 116.

As described below in detail, the HDD head position detector 116 monitors the positions of a head (e.g., the heads 108 and/or 110) with respect to the platters (e.g., the platters 102 and/or 104) to determine when the heads are likely to contact the platters. In particular, the HDD head position detector 116 processes signals from the drive reader and controller 114 to determine when the heads are oscillating vertically with respect to the platters (i.e., when the distance between the platters and the heads is varying). This oscillation is represented in FIG. 1 by the arrows 118 and 120. The oscillation of the heads 108, 110 precedes the heads 108, 110 contacting the platters 102, 104. Thus, if oscillations in the head positions can be detected, corrective action may be taken to control the platters and the heads before the heads contact the platters. For example, when a head begins oscillating with respect to the platter, the platter spin speed may be changed to prevent such oscillations from increasing to a point at which the heads contact the platters.

As shown in FIG. 1, in one example implementation the HDD head position detector 116 includes a peak detector 130, an amplifier/filter 132, a buffer 134, a window comparator 136, and logic 138. In operation of the HDD head position detector 116, the peak detector 130 receives signals from the drive reader and controller 114, the details of which are described below, and produces an output signal representative of the peaks in the received signal. The signal representative of the peaks is amplified and filtered by the amplifier/filter 132 and buffered by the buffer 134. The output of the buffer 134 is coupled to the window comparator 136, which also receives window references 137. Window references 137 are signals representative of the levels at which the signal provided by the buffer 134 will be determined to have oscillations. In one example, the window thresholds or references 137 may include both high and low reference signals or thresholds. The window comparator 136 provides, for example, an output signal indicative of when the signal from the buffer 134 falls outside the window set by the window references 137.

The logic 138, which as described below may be combinational logic, processes signal from the window comparator 136 and determines when a fault condition should be declared. The fault condition is declared by a change in the state of a fault signal 140. As described below, a fault condition may be indicated when the reference signals or thresholds are traversed, thereby indicating that an unacceptable level of read head position oscillation is taking place.

A monitor output 142 may be provided for testing or other purposes. In one example, the monitor output may provide a copy of the signal provided from the buffer 134.

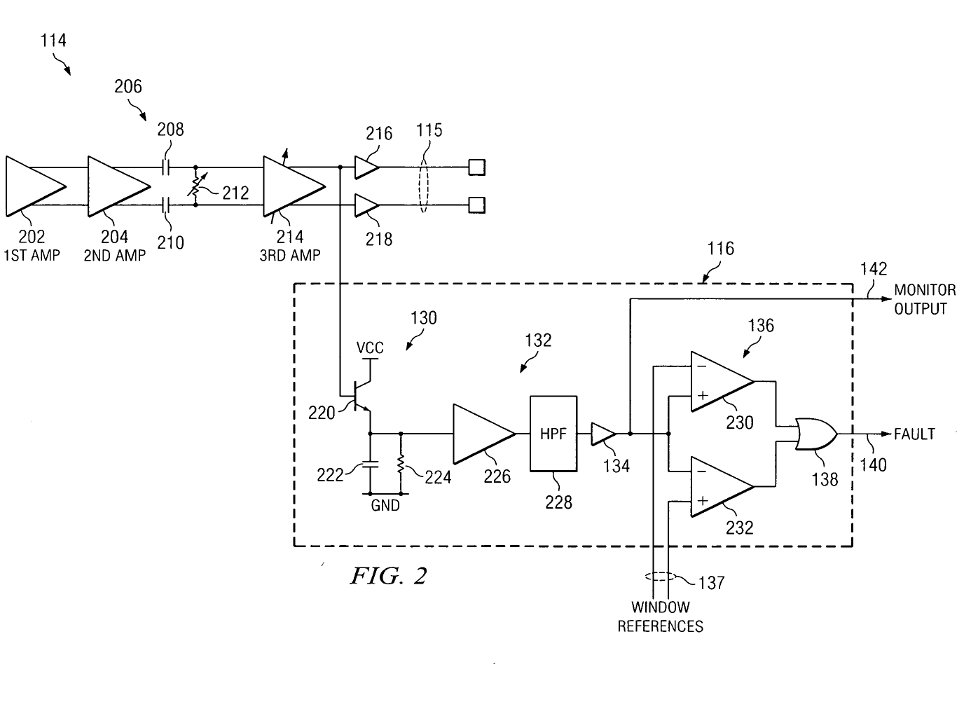

The drive reader and controller 114 may include a number of discrete components, examples of which are shown in FIG. 2. In one example, the drive reader and controller 114 may include a first differential amplifier 202 that receives differential signals from a read head (e.g., one of the heads 108 and 110). The output from the first differential amplifier 202 is provided to a second differential amplifier 204, the output of which is coupled to a high-pass filter 206, which may be constructed from series capacitors 208, 210 on the differential lines from the second amplifier 204 and a resistor 212, variable or fixed, coupled across the differential lines. The output of the high pass filter 206 is coupled to a variable gain amplifier 214, each differential output line of which is buffered by a buffer 216, 218. The read signal 115 is taken from the outputs of the buffers 216, 218.

As shown in FIG. 2, according to one example, an input signal for the HDD head position detector 116 is taken from the input to the buffer 216. Of course, the input signal could be taken from the input to the buffer 218 of from any other suitable place within the drive reader and controller 114. Additionally, in other implementations, differential signals may be used as an alternative to or in addition with single ended signals. The input signal is provided to the peak detector 130 and drives the base of a transistor 220 thereof. The transistor 220 has an emitter coupled to ground via a parallel combination of a capacitor 222 and a resistor 224. In one example implementation, the capacitor 222 may be 10 picofarads (pF), and the resistor 224 may be 50,000 Ohms (50 Kohms). The values of the capacitor 222 and the resistor 224 are selected to extract the envelope of the signal provided to the HDD head position detector 116.

The emitter of the transistor 220 provides the input to the amplifier/filter 132, which, in one example, includes an amplifier 226 having a gain of two and a high pass filter 228 having a −3 dB point of, for example, 16 kilohertz (KHz). The frequency of the high pass filter 228 is chosen to extract the envelope from the input signal.

The output signal from the high pass filter 228 is coupled to the buffer 134, the output of which may provide the monitor output 142. The output of the buffer 134 also provides an input to the window comparator 136. In one example, the window comparator 136 may be implemented using first and second operational amplifiers 230, 232 that also receive inputs from the window references 137. For example, the operational amplifier 230 may receive a high window threshold at its inverting input and may receive in buffer 134 output at its non-inverting input. When configured as such, the operational amplifier 230 will output a logical one when the signal from the buffer 134 exceeds the high window threshold and will be a logical zero otherwise. Conversely, the second operational amplifier 232 receives the buffer 134 output at its inverting input and receives a low widow threshold at its non-inverting input. When configured as such the second operational amplifier 232 will output a logical one when signal from the buffer 134 is lower than the low window threshold. Thus, when either the low window threshold or the high window threshold is traversed, one of the first and second operational amplifiers 230, 232 will output a logical one.

The outputs of first and second operational amplifiers 230, 232 are coupled to OR gate inputs, which are the logic 138. Thus, when either of the first and second operational amplifier outputs is a logical one, a fault will be declared on the fault signal 140.

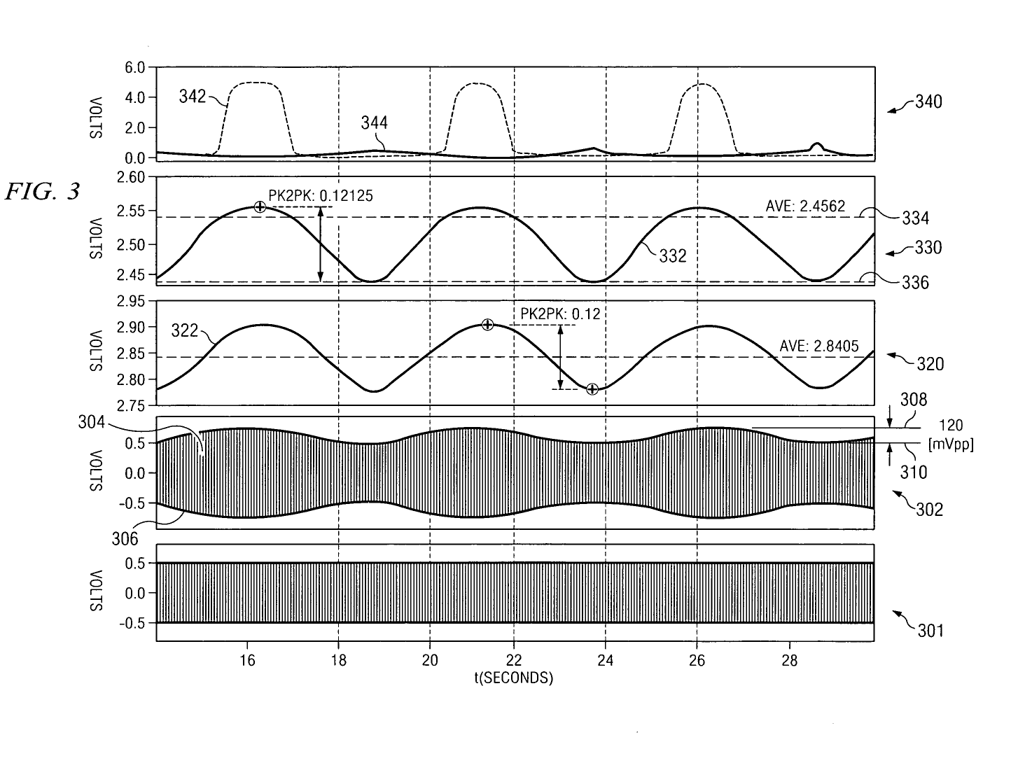

The operation of the HDD head position detector 116 shown in FIG. 2 will now be described in conjunction with the signal plots shown in FIG. 3.

In FIG. 3, the signal at the buffer 216 may have no oscillations because the heads are not moving with respect to the platters. Thus, as shown at the plot 301, the signal at the buffer 216 may have a constant envelope. However, in the case of oscillations caused by head movement, resulting signals are shown at the plot 302, in which 304 refers to the read signals and 306 refers to the envelope of the signals 304. As will be readily appreciated, the read signals 304 are extremely high in frequency and include servo control signals and modulated signals representing data read by the head from the platter. However, the magnitude of the envelope 306 varies with the distance between the read head and the platter because signals read from the platter will be stronger when the head is near the platter and will be weaker when the head is far from the platter due to the magnetic reading of the platter by the head. For example, the peak envelope amplitude 308 occurs when the head is closest to the platter and the trough envelope amplitude 310 occurs when the head is farthest from the platter. Thus, a measurement of the envelope 306 will provide an indication as to how much the head is oscillating with respect to the platter. When such oscillations are too significant, there is an increased chance of the head striking the platter.

Plot 320 shows an output of the amplifier 226 at reference numeral 322, which is an amplified version of envelope 306 of the read signals 304. Plot 330 shows the output from the buffer 134 at reference numeral 332. Additionally, the high window threshold and the low window threshold are shown at reference numerals 334, 336, respectively. As explained above, exceeding the window thresholds (i.e., any signal outside the window defined by the low and high window thresholds) will result in a fault being declared. The window thresholds are selected such that oscillation of the head that cause the read signal to fluctuate in a manner indicative of an occurred or impending contact between the head and the platter results in the declaration of a fault. In case of no oscillation, as shown at reference numeral 301, the envelope of the signal from the buffer 216 is flat, so the signal 320 and signal 330 do not have envelope that vary over time.

During oscillations caused by head movement with respect to the platter, the typical envelope amplitude 306 varies between 1-10%, as reflected in the difference between 308 and 310 is 1-10% of amplitude of the signal 304 when oscillating. The amplitude of signal 304 is predictable from head sensitivity and system gain of 114 and 132/134. Thus, from plot 320, it can be seen where in time the output of the buffer 134 (i.e., the signal at reference numeral 332) exceeds the thresholds 334, 336. In such as case, exceeding the thresholds means being above the high threshold or below the low threshold. This is also referred to as traversing the threshold.

Plot 340 shows the outputs of comparators 230, 232 versus time. In plot 340, the output of the comparator 230 is shown at reference numeral 342 and the output of the comparator 232 is shown at reference numeral 344. Of course, those having ordinary skill in the art will recognize that the OR operation of the signals at 342 and 344 results in a signal having a logical one whenever one or both of the signals 342, 344 is high. Thus, whenever the envelope of the input signal varies in a predetermined manner or to a predetermined extent, a fault is declared as an indication that contact between the head and the platter may have occurred or is likely to occur. Thus, corrective action, such as slowing the platter speed, may be taken in response to the fault declaration to ensure that the undesired head/platter contact does not occur. In this explanation a window comparator is used to detect envelope oscillation, but it is feasible to detect envelope oscillation using only one comparator output of 230 or 232 from FIG. 3.

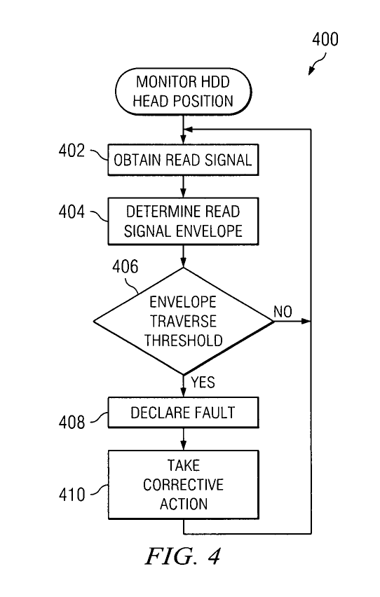

A process of monitoring HDD head position 400 is shown in FIG. 4. The process begins by obtaining a read signal or any other signal that varies with head distance relative to a platter (block 402). The envelope of the read signal is then obtained (block 404) because the envelope of the read signal indicates the extent to which the head distance is varying with respect to the platter.

After the envelope is determined (block 404), the process 400 determines if the envelope traverses one or more thresholds (block 406). That is, the process 400 determines if the head is excessively close to the platter thereby resulting in a high envelope level, or if the head is excessively far from the platter thereby resulting in a low envelope level.

If the thresholds are not traversed (block 406), the process 400 continues to operated by obtaining a read signal and processing the same as described above. Conversely, if a threshold is traversed (block 406), a fault is declared (block 408) and corrective action may be taken (block 410). Corrective action may include, but is not limited to slowing the spin speed of the platters.

The foregoing process may be implemented using hardware, software, firmware, or any suitable combination thereof. For example, the forgoing process may be implemented using the circuit diagrams described herein or may be implemented using a processor, such as a digital signal processor or the like, programmed with software to obtain the read signal envelope and to compare the same to thresholds.

Although certain apparatus constructed in accordance with the teachings of the invention have been described herein, the scope of coverage of this patent is not limited thereto. On the contrary, this patent covers every apparatus, method and article of manufacture fairly falling within the scope of the appended claims either literally or under the doctrine of equivalents.

What is claimed is:

1. A method of detecting head position in a hard-disk drive, the method comprising:
obtaining a read signal from a head reading information from a disk;
determining a signal characteristic based on the read signal, wherein the signal characteristic is related to a distance between the head and the disk;
comparing the signal characteristic to a threshold; and
providing an indication when the signal characteristic crosses the threshold.

2. The method of claim 1, wherein determining the signal characteristic comprises determining an envelope of the read signal.

3. The method of claim 2, wherein comparing the signal characteristic to the threshold comprises comparing the envelope of the read signal to the threshold.

4. The method of claim 3, further comprising taking corrective action in response to the indication.

5. The method of claim 4, wherein the corrective action comprises altering a speed at which the disk is turning.

6. The method of claim 5, wherein the threshold is a high threshold, the method further comprising comparing the signal characteristic to a low threshold.

7. A hard-disk drive head position detector comprising:
a peak detector configured to receive a read signal via a hard-disk drive head and to determine an envelope of the read signal;
a comparator configured to compare a signal based on the envelope of the read signal to a threshold;
logic to indicate the result of the comparison of the signal based on the envelope of the read signal and the threshold.

8. The hard-disk drive head position detector of claim 7, further comprising an amplifier configured to amplify the envelope of the read signal and to provide the amplified envelope of the read signal to the comparator.

9. The hard-disk drive head position detector of claim 8, wherein the signal based on the envelope of the read signal comprises the amplified envelope of the read signal.

10. The hard-disk drive head position detector of claim 9, wherein the logic is configured to indicate a fault when the signals based on the envelope of the read signal traverse the threshold.

11. The hard-disk drive head position detector of claim 9, wherein the logic is configured to indicate a fault when the signals based on the envelope of the read signal exceed the threshold.

12. The hard-disk drive head position detector of claim 7, wherein the comparator is a first comparator and the threshold is a first threshold, the hard-disk drive head position detector further comprising a second comparator configured to compare the signal based on the envelope of the read signal to a second threshold.

13. The hard-disk drive head position detector of claim 12, wherein the first threshold is higher than the second threshold.

14. A hard-disk drive system comprising:
a hard-disk drive platter;
a hard-disk drive read head configured to read information from the hard-disk drive platter and to produce a read signal;
a peak detector configured to determine an envelope signal based on the read signal;
an amplifier configured to amplify the envelope signal to produce an amplified envelope signal;
a filter configured to filter the amplified envelope signal to produce a filtered and amplified envelope signal;
a first comparator configured to compare the filtered and amplified envelope signal to a high threshold;
a second comparator configured to compare the filtered and amplified envelope signal to a low threshold; and
logic coupled to the first and second comparators to indicate when the filtered and amplified envelope signal traverses the low threshold or the high threshold.

15. The hard-disk drive system of claim 14, wherein the logic is configured to indicate a fault when the filtered and amplified envelope signal has a greater magnitude than the high threshold.

16. The hard-disk drive system of claim 15, wherein the logic is configured to indicate a fault when the filtered and amplified envelope signal is more negative than the low threshold.

17. A hard-disk drive system comprising:
a hard-disk drive platter;
a hard-disk drive read head configured to read information from the hard-disk drive platter;
a hard-disk drive head position detector configured to a receive a signal via the hard-disk drive read head and to determine if oscillations in the distance between the hard-disk drive platter and the hard-disk drive read head indicate that contact between the hard-disk drive platter and the hard-disk drive read head is likely to occur.

18. The hard-disk drive system of claim 17, wherein the hard-disk drive head position detector is configured to indicate that contact between the hard-disk drive platter and the hard-disk drive read head has occurred.

19. The hard-disk drive system of claim 17, wherein the hard-disk drive head position detector is configured to indicate a fault when contact between the hard-disk drive platter and the hard-disk drive read head is likely to occur.

20. The hard-disk drive system of claim 17, wherein the hard-disk drive head position detector is configured to indicate a fault when contact between the hard-disk drive platter and the hard-disk drive read head has occurred.
